(19) United States
(12) Patent Application Publication
(10) Pub. No.: US 2024/0008450 A1
(43) Pub. Date: Jan. 11, 2024

(54) FINGER BRUSH SLEEVE FOR PET GROOMING

(71) Applicant: INSTAPURR, LLC, Claremont, CA (US)

(72) Inventor: Istiaque Baig, Claremont, CA (US)

(21) Appl. No.: 18/041,551

(22) PCT Filed: Aug. 16, 2021
(86) PCT No.: PCT/US2021/046149

§ 371 Date: Feb. 14, 2023

Related U.S. Application Data
(60) Provisional application No. 62/706,428, filed on Aug. 16, 2020.

(51) Int. Cl. A01K 13/00; A46B 5/04

(52) U.S. Cl. CPC A01K 13/002; A46B 5/04; A46B 2200/1093

(57) ABSTRACT

The invention relates to a finger brush sleeve for pet grooming that allows pet owners to groom, pet, brush, and bond with pets while multi-tasking. The brush is lightweight and flexible with bristles all around the finger sleeve to conform to the various curved areas of the pet. In addition, the brush can include animal features such as ears, whiskers, and paws.

### CROSS-REFERENCE TO RELATED APPLICATIONS

This application claims the priority filing benefit of U.S. Provisional Application No. 62/706,428, filed Aug. 16, 2020, which is incorporated herein by reference in its entirety.

### FIELD OF THE INVENTION

The present invention relates to a finger brush sleeve for grooming pets, particularly for cats and dogs.

### BACKGROUND OF THE INVENTION

Pet owners bond with their cat or dog via physical attention. A common form of physical attention is brushing and grooming which not only provide joy to the pets but also serve as removing loose fur from the animal. The art of pet grooming is a mutual skill and benefit. Pet owners gain satisfaction and emotional support from their furry companions while pets instinctively seek attention and petting from their owners. And brushing and grooming can also improve blood circulation for skin and fur health. As people tend to spend their time reading, watching, or using computers, it becomes increasingly difficult to invest the time to brush their pets daily and with a frequency that will improve the bond between human and animal and the pet's overall health. Traditional brushes require the full hand and attention while glove style brushes are uncomfortable and cause hand fatigue. Existing brush designs for grooming pets also fail to provide a dedicated solution for brushing the chin and face, which is a major source of satisfaction for the pet.

The present invention will remove the attention required, improve the versatility and function of traditional brushes, and increase the satisfaction of the brushing experience for the pet. And the present invention is the first feline grooming brush designed for the cat's face. It is made of a soft polymer with cone-like bristles/spikes that is safe for animals and easy to clean. It can be used with any finger. The bristles are designed to remove hair, stimulate pet's skin and muscles, and provide overall wellness. The inside of the device has ridges for user comfort, airflow, and ease of removal.

This invention is an ergonomic method to maximize physical grooming time and accommodate multitasking on smart phones, televisions, and computers. This will also promote the seeking of attention that most pet owners crave.

### SUMMARY OF THE INVENTION

The present invention relates to a finger brush sleeve for grooming pets. In one embodiment of the invention, the finger brush sleeve comprises a finger sleeve and a plurality of bristles extending from the finger sleeve. The finger brush sleeve further comprises animal features such as ears, whiskers, and paws. The ears are mounted on the top of the sleeve on both sides.

The finger sleeve is a hollowed cylindrical apparatus, and the plurality of bristles extending from the sleeve are soft, flexible, and cone shaped. The finger brush sleeve is compatible with different finger sizes and has soft bristles on all sides for maximum versatility.

The plurality of bristles can be elegantly placed to maximize the surface area of the finger brush sleeve for grooming. As the finger is inserted, the top and bottom contours of the finger brush sleeve can provide the ability to conform to curved areas like the neck and chin. From this three-dimensional bristle layout, the user can scratch and brush all areas of the pets with maximum ease and comfort and without the need to adjust the finger brush sleeve. A ridged interior can improve grip and allow air circulation for the finger. The soft bristles can provide a safe and pleasant scratching experience for the pet. And the lightweight materials of the finger brush sleeve can allow for extended brushing and bonding experience between human and pet.

In one embodiment, the finger brush sleeve has uniform soft bristles all around the sleeve. In another embodiment, the finger brush sleeve comprises two sets of bristles. One side of the sleeve comprises one length of the bristles and the other side comprises a different length of the bristles for versatility. In yet another embodiment, the finger brush comprises the bristles on only one side of the sleeve.

In another embodiment, the finger brush sleeve can fit a single finger, and in another embodiment, the finger brush sleeve can fit two fingers. In a further embodiment, the finger brush sleeve can fit multiple fingers, without obstructing the ability to perform a brushing motion.

In some embodiments, the finger brush sleeve can have animal features as aesthetic elements. And the ears on the finger brush sleeve can be designed to scratch or rub the pet's outer ears to give the pet great satisfaction.

Other methods, features, systems, and advantages of the present invention will be or become apparent to one of ordinary skill in the art upon examination of the following drawings and detailed description. It is intended that all such additional methods, features, systems, and advantages be included within this description, be within the scope of the present invention, and be protected by the accompanying claims. In addition, all optional and preferred features and modifications of the described embodiments are usable in all embodiments of the invention taught herein. Further, the individual features of the dependent claims, as well as all optional and preferred features and modifications of the described embodiments are combinable and interchangeable with one another.

### BRIEF DESCRIPTION OF THE DRAWINGS

The foregoing aspects and advantages of this invention may become apparent from the following detailed description with reference to the accompanying drawings. The components in the drawings are not necessarily to scale; emphasis is instead being placed upon clearly illustrating the principles of the present invention. And, in the drawings, like reference numerals designate corresponding parts throughout the several views.

FIG. 1 is a side view of the invention showing the finger inserted in the sleeve.

FIG. 2 is top view of the invention showing a finger inserted in the sleeve.

FIG. 3 is a front view of the invention.

FIG. 4 is a rear view of the invention.

FIG. 5 is a side perspective view of the invention.

FIG. 6 is a rear perspective view of the invention.

Additional advantages of the invention will be set forth in part in the description below, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

It will be readily understood that the components of the embodiments, as generally described and illustrated in the figures herein, may be arranged and designed in a wide variety of different configurations in addition to the described representative embodiments. Thus, the following more the detailed description of the representative embodiments, as illustrated in the figures, is not intended to limit the scope of the embodiments, as claimed, but is merely illustrative of representative embodiments.

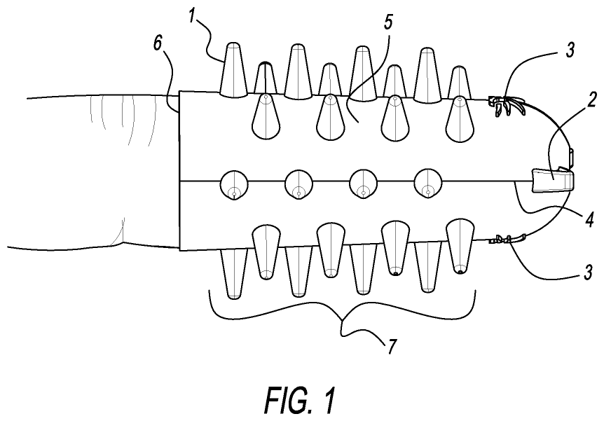

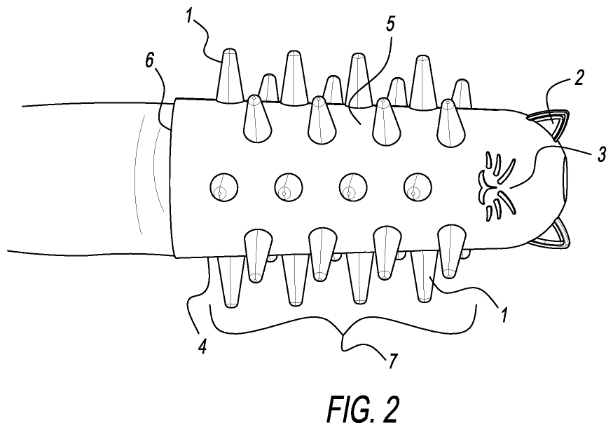

FIG. 1 illustrates a side view and FIG. 2 illustrates a top view of a hollow cylindrical finger sleeve with flexible, soft, cone shaped bristles 1 on all sides and a finger inserted in the sleeve. The soft cones can be made of any flexible material. The present invention is designed to capture hair, stimulate the skin and fur, and to provide a comfortable grooming experience. When the finger brush sleeve is not in use, both sides lay flat. When a finger is inserted, the finger brush sleeve stretches to create contour sides 5. Contour and staggard layout 7 arranged to maximize surface area while conforming to areas such as chin, neck, and other curved areas of the animal. The user will move the finger in a back-and-forth motion, unobstructed, to brush the pet. The bristles spacing 5 is sufficient to remove hair captured. The bottom of the finger brush sleeve has a hole 6 to slip in a finger. The side edges at seam 4 are stiff for cheek rubbing. As illustrated in FIGS. 4 and 6, the inner surface is ridged 8 to improve grip and to promote airflow.

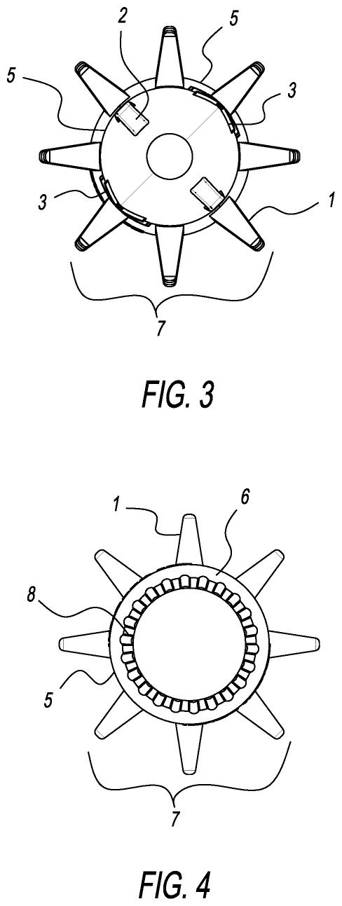

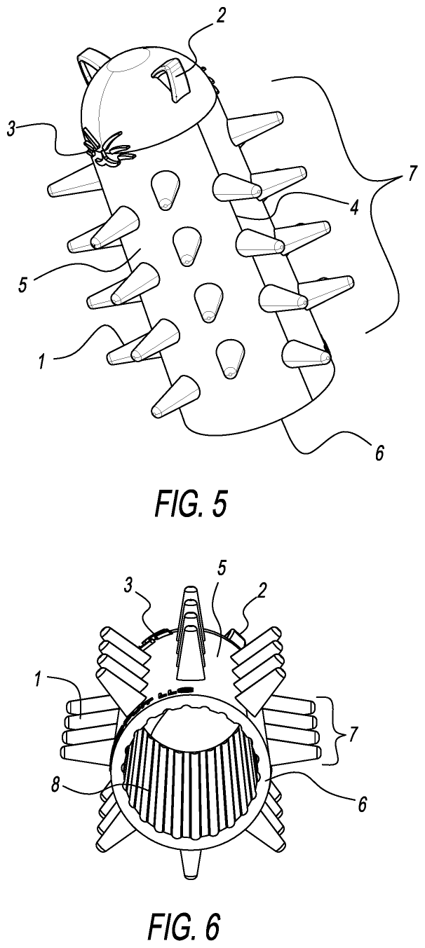

FIG. 3 shows a front view and FIG. 4 shows a rear view of the finger brush sleeve. And FIG. 5 illustrates a side perspective view FIG. 6 illustrates a rear perspective of the finger brush sleeve.

The finger brush sleeve resembles household animals with feature like ears 2, whiskers 3, and paws. And the ears on the finger brush sleeve can be designed to scratch or rub the pet's outer ears which gives the pet great satisfaction

In one embodiment, the finger brush sleeve for pet grooming is a unibody design made of a flexible, soft material. Examples may include, but are not limited to, the materials such as silicon, rubber, plastic, resin, polymer, and the like. In another embodiment, the finger brush sleeve can be made of a material with varying degree of softness, comfort, and fit. In some embodiments, the finger brush sleeve can be a wide enough for multiple fingers. And in some embodiments, the finger brush sleeve can have a multiple finger design to fit more than one finger.

In another embodiment, the length of the finger brush sleeve can be between about 1 inch and about 3 inches. In yet another embodiment, the width of the finger brush sleeve can be between about 0.5 inch and about 2 inches. In a further embodiment, the thickness of the sleeve can be between about 0.05 inch and about 0.5 inch.

In one embodiment, the shape of the bristles can be cone, spike, or the combination thereof. In another embodiment, the bristles can be only one side of the finger brush sleeve. In yet another embodiment, the length of the bristles can be between about 0.1 inch and about 0.75 inch and the width at the base of the bristle can be between about 0.125 inch and about 0.25 inch.

In some embodiments, the finger brush sleeve can have one length of the bristles on one side and another length of bristles on the other side of the sleeve.

In one embodiment, the finger brush sleeve can have stiff side edges at the seam for cheek rubbing. In another embodiment, the brush can have uniform bristles all around the sleeve.

In some embodiments, the finger brush sleeve resembles household animals with feature such as ears, whiskers, and paws.

In one embodiment, the length of the ears on the finger brush sleeve can be between about 0.125 inch and about 0.25 inch. In another embodiment, the width of the ears can be between about 0.125 inch and about 0.25 inch. And in yet another embodiment, the thickness of the ears can be between about 0.05 inch and about 0.5 inch.

Many modifications and other aspects disclosed herein will come to mind to one of ordinary skill in the art to which the disclosed compositions and methods pertain having the benefit of the teachings presented in the foregoing descriptions and the associated figures. Therefore, it is to be understood that the inventions are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this invention and to be encompassed by the claims herein.

Although specific terms are employed herein, they are used in a generic and descriptive sense only and not for purposes of limitation.

All publications mentioned herein are hereby incorporated herein by reference for the purpose of disclosing and describing, for example, the methods and/or materials that are described in the publications which might be used in connection with the presently described invention. The publications discussed herein are provided solely for their disclosure prior to the filing date of the present application. Nothing herein is to be construed as an admission that the present invention is not entitled to antedate such disclosure by virtue of prior invention. Further, the dates of publication provided herein can be different from the actual publication dates, which can require independent confirmation.

Although the invention has been explained in relation to its various embodiments, it is to be understood that many other possible modifications and variations can be made without departing from the spirit and scope of the invention as hereinafter claimed.

1. A finger brush sleeve for grooming a pet, comprising:
a hollow cylindrical shaped finger sleeve, and
a plurality of cone shaped bristles extending from the finger sleeve, where the cone shaped bristles are sufficiently spaced apart along the hollow cylindrical shaped finger sleeve to allow hair removed from the pet to be captured between the cone shaped bristles.

2. (canceled)

3. (canceled)

4. The finger brush sleeve of claim 1, wherein the finger brush sleeve comprises a flexible material.

5. The finger brush sleeve of claim 1, wherein the bristles are flexible.

6. The finger brush sleeve of claim 1, wherein the plurality of bristles are oriented circumferentially around the finger sleeve.

7. The finger brush sleeve of claim 1, wherein the finger brush sleeve further comprises animal features.

8. The finger brush sleeve of claim 7, wherein the animal features comprise animal ear shaped bristles mounted on a top of the finger sleeve.

9. The finger brush sleeve of claim 7, wherein the animal features comprise whiskers, paws, or any combination thereof.

10. (canceled)

11. The finger brush sleeve of claim 1, wherein the pet comprises at least one cat, at least one dog, or any combination thereof.

12. The finger brush sleeve of claim 1, further comprising a staggered layout, where the staggered layout is configured to conform to a shape of a curved body part of the pet.

13. The finger brush sleeve of claim 12, where the curved body part is a chin, a neck, or any combination thereof.

14. The finger brush sleeve of claim 4, where the flexible material comprises silicon, rubber, plastic, at least one polymer, at least one resin or any combination thereof.

15. The finger brush sleeve of claim 1, having a length from 1 to 3 inches.

16. The finger brush sleeve of claim 1, having a width from 0.5 to 2 inches.

16. The finger brush sleeve of claim 1, having a thickness from 0.05 to 0.5 inches.

17. The finger brush sleeve of claim 1, the cone shaped bristles having a length from 0.1 to 0.75 inches.

18. The finger brush sleeve of claim 1, the cone shaped bristles having a width from 0.125 to 0.25 inches, as measured at a base of the cone.

19. The finger brush sleeve of claim 1, comprising at least one seam edge, where the at least one seam edge is configured to rub at least one cheek of the pet.
